(19) United States
(12) Patent Application Publication
(10) Pub. No.: US 2013/0048583 A1
(43) Pub. Date: Feb. 28, 2013

(54) SOLAR APPARATUS SUPPORT STRUCTURES AND SYSTEMS

(71) Applicant: Darin Kruse, Simi Valley, CA (US)

(72) Inventor: Darin Kruse, Simi Valley, CA (US)

(21) Appl. No.: 13/592,222

(22) Filed: Aug. 22, 2012

Related U.S. Application Data
(60) Provisional application No. 61/526,190, filed on Aug. 22, 2011.
(60) Provisional application No. 61/608,568, filed on Mar. 8, 2012.

(51) Int. Cl. F24J 2/52; B23P 15/12

(52) U.S. Cl. 211/41.1; 29/897.31

(57) ABSTRACT

Described herein are solar apparatus support structures, apparatus and systems as well as methods of installing and using the solar apparatus structures, apparatus and systems.

### CROSS REFERENCE TO RELATED APPLICATIONS

The present application claims the benefit under 35 U.S.C. §119(e) to U.S. Provisional Application Ser. No. 61/526,190 filed Aug. 22, 2011 and 61/608,568 filed Mar. 8, 2012, the entire contents of all of which are hereby incorporated by reference in their entirety.

### FIELD

Described herein are solar apparatus support structures and apparatus used to mount solar apparatus, modules and/or arrays.

### BACKGROUND

As time passes, some renewable energy production costs are approaching nexus with hydrocarbon fuel power generating costs. As this occurs, faster and more cost effective methods of deploying renewable energy are required to achieve parity.

### SUMMARY

Described herein are solar apparatus supports and systems as well as methods of installing and using the apparatus and systems which can meet the need for faster and more cost effective methods of deploying renewable energy. Further described are solar apparatus support structures and components used to mount solar apparatus, modules and/or arrays.

In one embodiment, described herein are solar apparatus support structures comprising: a first curved member and a first linear member joined at a point; and a linear coupling member adjoined to the first curved member at a first connection point and the first linear member at a second connection point.

In one embodiment, described herein are methods of installing a solar support structure comprising: a. selecting a first curved member and a second linear member; b. affixing a first end of the first curved member to a first foundation, a second end of the first curved member to a second foundation and a second first end of first linear member to the second foundation; c. joining a linear coupling member the first curved member at a first connection point and the second linear member at a second connection point; d. attaching at least two joists to the linear coupling member; and e. attaching one or more solar apparatus to the at least two joists.

The structures can further comprise a first foundation and a second foundation. In some embodiments, the first curved member and the first linear member can be tubular and/or have a circular, square, or rectangular cross-section. The first curved member and the first linear member can be coupled at the second foundation using an adhesive, fastener, or welding. The first curved member and the first linear member can be separated by an angle of between about 30 degrees and about 100 degrees. In one embodiment, the is can be about 75 degrees.

In other embodiments, the linear coupling member can be adjoined to the first linear member at an end opposite to the foundation. The first curved member can include at least two angles.

In some embodiments, the structures can further comprise at least two joists coupled perpendicularly to the linear coupling member and a solar apparatus mounted to the at least two joists.

In some embodiments, the first curved member, first linear member, and linear coupling member can be joined before assembly at an installation site.

In one embodiment, described are solar support structures comprising: a first curved member having a first end coupled to a first foundation and a second end coupled to a second foundation and a first linear member joined at a point on the second foundation; a linear coupling member adjoined to the first curved member at a first connection point and the first linear member at a second connection point; at least two joists coupled to the linear coupling member; and at least one solar apparatus joined to the at least two joists, wherein the first curved member and the first linear member meet at an angle of about 75 degrees.

Solar support structures are also described comprising: a first curved member having a first end coupled to a first foundation and a second end coupled to a second foundation and a first linear member joined at a point on the second foundation; a linear coupling member adjoined to the first curved member at a first connection point and the first linear member at a second connection point; at least two joists coupled to the linear coupling member; and at least one solar apparatus joined to the at least two joists. In one embodiment, the first curved member and the first linear member can meet at an angle of about 75 degrees. In another embodiment, the solar apparatus support structure can resist a wind load of between about 13,900 N to about 40,000 N.

### BRIEF DESCRIPTION OF THE DRAWINGS

FIG. 1 illustrates a perspective view of a solar apparatus support structure including foundations according to the present description.

FIG. 2 illustrates a side exploded view of the solar apparatus support structure including foundations of FIG. 1 further including joists and a solar apparatus.

FIG. 3 illustrates a rear perspective view of the exploded view of FIG. 2.

FIG. 4 illustrates a side view of an assembled solar apparatus support structure including joists and a solar apparatus.

FIG. 5 illustrates a rear perspective view of the structure of FIG. 4.

FIG. 6 illustrates a rear perspective view of another assembled solar apparatus support structure including joists and a solar apparatus.

FIG. 7 illustrates a side view of the assembled solar apparatus support structure of FIG. 6.

FIG. 8A illustrates a side view of an example coupling arrangement between a solar apparatus support structure and a foundation. FIG. 8B illustrates a top view of the coupling arrangement of FIG. 8A.

FIG. 9 illustrates a side view of the assembled solar apparatus support structure of FIG. 6 exploded from the foundations.

FIG. 10 illustrates a cross section from FIG. 9.

FIG. 11 illustrates another cross section from FIG. 10.

FIG. 12 illustrates sample design parameters from Example 1.

### DETAILED DESCRIPTION

Described herein are solar apparatus support structures, components and systems as well as methods of installing and using the solar apparatus support structures, apparatus and systems. A solar apparatus support structure as described herein can comprise a first curved member and a first linear member joined at a point; and a linear coupling member adjoined to the first curved member at a first connection point and the first linear member at a second connection point. The solar apparatus support structures described can resist typical or usual wind loads.

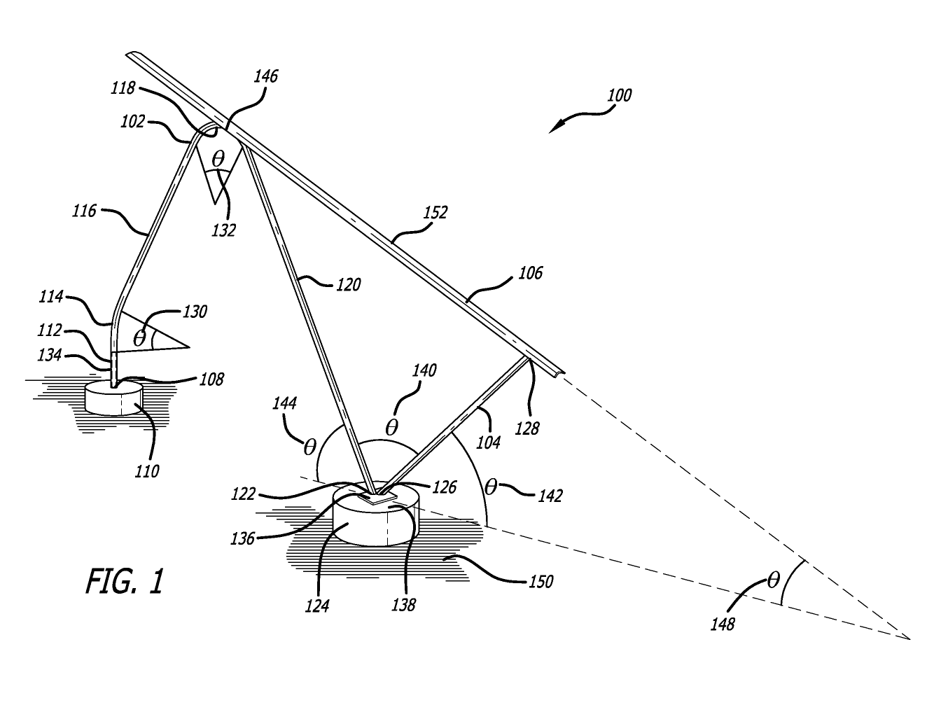

One embodiment of a solar apparatus support structure 100 according to the present description is illustrated in FIG. 1. In FIG. 1, first curved member 102, first linear member 104, and linear coupling member 106 are illustrated. First curved member 102 can include first end 108 coupled to first foundation 110, first linear portion 112, first curved section 114, second linear section 116, second curved section 118 and third linear section 120 terminating at second end 122 which is attached to second foundation 124. First linear member 104 can be substantially linear having third end 126 and fourth end 128. Third end 126 is coupled to second foundation 124 and fourth end 128 is coupled to linear coupling member 106.

First linear portion 112 can have a length of about 5 in, about 6 in, about 7 in, about 8 in, about 9 in, about 10 in, about 11 in, about 12 in, about 13 in, about 14 in, or about 15 in or from about 5 in to about 15 in, about 8 in to about 12 in, about 9 in to about 10 in or any length bound by, or between any of these values. In one embodiment, first linear portion 112 can have a length of about 9.3 in. First curved section 114 can form a first angle 130 of about 30 degrees, 40 degrees, 45 degrees, 50 degrees, or about 55 degrees, or from about 30 degrees to about 55 degrees, about 40 degrees to about 45 degrees or any angle bound by, or between any of these values. In one embodiment, first angle 130 can be about 43 degrees.

Second linear section 116 can have a length of from about 20 in to about 60 in, about 30 in to about 50 in, about 42 in to about 48 in or any length bound by, or between any of these values. In one embodiment, second linear section 116 can have a length of about 46 in.

Second curved section 118 can form a second angle 132 of about 90 degrees, 100 degrees, 110 degrees, 120 degrees, or about 130 degrees, from about 90 degrees to about 120 degrees, about 100 degrees to about 110 degrees or any angle bound by, or between any of these values. In one embodiment, second angle 132 can be about 107 degrees.

Third linear section 120 can have a length of from about 30 in to about 80 in, about 40 in to about 70 in, about 50 in to about 60 in or any length bound by, or between any of these values. In one embodiment, third linear section 120 can have a length of about 57 in.

First linear member 104 can have a length of from about 20 in to about 60 in, about 30 in to about 50 in, about 30 in to about 40 in or any length bound by, or between any of these values. In one embodiment, first linear member 104 can have a length of about 36 in or about 35.67 in.

In some embodiments, first curved member 102 and first linear member 104 can have any shape that provides adequate structural support. For example, shapes can include cross sections that are circular, square, rectangular, trapezoidal, oval, torx, diamond, triangular, and the like. Further, first curved member 102 and first linear member 104 can be hollow, substantially hollow or solid. For example, if plastic, they may be solid to supply more support. If hollow or substantially hollow, they can also include internal bracing to increase support potential without substantially increasing overall weight of an arm compared to an arm with a solid linear portion.

Further, first curved member 102 and first linear member 104 can be formed of materials supplying sufficient forces to support the required structural load. For example, first curved member 102 and first linear member 104 can be made of plastic, glass fiber reinforced polymer (GFRP), carbon fiber, metal, metal alloy or a combination thereof. Examples of metals include aluminum, titanium, iron, and other common structural metals. Examples of metal alloys can include steel.

In one embodiment, first curved member 102 and first linear member 104 can be formed of ANSI 1.25 in diameter Schedule 40 steel pipe. First curved member 102 and first linear member 104 can be formed of pipe having an inner diameter of about 1.38 in, an outer diameter of about 1.66 in, a wall thickness of about 0.14 in, a cross-sectional area of about 0.62 in², a second moment of area of 0.18 in⁴, and a weight of about 2.2 lb/ft. In another embodiment, first curved member 102 and first linear member 104 can be formed of ANSI 2 in diameter Schedule 80 steel pipe. First curved member 102 and first linear member 104 can be formed of pipe having an inner diameter of about 1.939 in, an outer diameter of about 2.375 in, a wall thickness of about 0.218 in, a cross-sectional area of about 1.477 in², a second moment of area of 0.868 in⁴, and a weight of about 5.027 lb/ft.

As further illustrated in FIG. 1, first curved member 102 is attached to both first foundation 110 and second foundation 124, and first linear member 104 is attached to second foundation 124. Each foundation can independently be any foundation known in the art. For example, a foundation can be a cement slab, ballasted mount, an anchor, a post foundation pier, or the like. In one embodiment, the foundation can be a post tensioned shallow gravel column foundation as described in Applicants U.S. provisional patent application No. 61/526,192, which is incorporated herein in its entirety for all that it discloses regarding post tensioned shallow gravel column foundations. A post tensioned shallow gravel column foundation can include a reaction plate coupled to a tensioning rod, a column of compacted aggregate, a top plate and a securing means such as a bolt atop the top plate to maintain the force stored within the aggregate column. Tensioning rod 134 generally can protrude out the top of the foundation itself.

Further, first curved member 102 and first linear member 104 can be attached to first foundation 110 and second foundation 124 by any means known in the art. In one embodiment, first foundation 110 and second foundation 124 can have tensioning rod 134 protruding from the foundation. Tensioning rod 134 can be sized such that it can fit within the inner dimensions of first linear portion 112. As such, in some embodiments, a linear portion of first curved member 102 can be slid over a tensioning rod and secured in place. In one embodiment, adhesive is applied to tensioning rod 134, and then, first linear portion 112 is slid over tensioning rod 134 securing it in place. Suitable fasteners or adhesives can include industrial grade fasteners, single or two part urethane and/or single or two part epoxy adhesives.

Other securing methods such as bolting, screwing, a retractable pin, a removable pin, clamping and the like can be used to couple a member to a foundation. For example, tensioning rod 134 can be threaded, first linear portion 112 can be reverse threaded on the interior, and the two can be screwed together.

Further, second end 122 of first curved member 102 and third end 126 of first linear member 104 are attached to second foundation 124. In another embodiment, plate 136 is attached directly to top face 138 of second foundation 124 using such methods as gluing or bolting. Both second end 122 and third end 126 can then be attached to plate 136 for example, by welding or gluing. In still another embodiment, plate 136 is welded to second end 122 and third end 126 prior to installation and glued or bolted to foundation 124 thereafter.

The marriage of second end 122 and third end 126 at plate 136, can be offset by third angle 140. Third angle 140 can be varied depending on terrain, height desired, structural requirement and the like. Generally, third angle can be 180 degrees less fourth angle 142 and fifth angle 144.

Third angle 140 can be of any degree as long as the final structure can support its intended load. In aspects of this embodiment, third angle 140 can be about 60 degrees, about 65 degrees, about 70 degrees, about 75 degrees, about 80 degrees, about 85 degrees, or about 90 degrees, from about 70 to about 80 degrees or any angle bound by, or between any of these values. In other embodiments, third angle 140 can be about 75 degrees.

Linear coupling member 106 can be attached to both first curved member 102 and first linear member 104. In one embodiment, linear coupling member 106 is attached to first curved member 102 at first connection point 146 within second curved section 118 and first linear member 104 at fourth end 128.

Linear coupling member 106 can have a length of from about 80 in to about 130 in, about 90 in to about 120 in, about 100 in to about 110 in or any length bound by, or between any of these values. In one embodiment, linear coupling member 106 can have a length of about 106 in. Further, linear coupling member 106 can be oriented at sixth angle 148 relative to ground 150. Sixth angle 148 can be about 15 degrees, 20 degrees, 25 degrees, 30 degrees, 35 degrees, 40 degrees or about 45 degrees, or from about 15 degrees to about 45 degrees, about 20 degrees to about 30 degrees or any length bound by, or between any of these values. In one embodiment, sixth angle 148 can be about 25.5 degrees. Sixth angle 148 can be varied to enable top surface 152 to capture the most sunlight.

Linear coupling member 106 can be formed of materials of sufficient strength to support the required structural load. For example, linear coupling member 106 can be made of plastic, GFRP, carbon fiber, metal, metal alloy or a combination thereof. Examples of metals include aluminum, titanium, iron, and other common structural metals. Examples of metal alloys can include steel. In one embodiment, linear coupling member 106 can be a hot rolled steel channel bar. In one embodiment, the steel channel bar can have a width of about 5.0 in, a leg depth of about 1.75 in, a thickness of about 0.19 in a cross-sectional area of about 1.97 in², a second moment of area of about 7.49 in⁴, and a weight of about 6.7 lb/ft. In another embodiment, the steel channel bar can have a width of about 8.0 in, a leg depth of about 2.26 in, a thickness of about 0.22 in a cross-sectional area of about 3.37 in², a second moment of area of about 32.50 in⁴, and a weight of about 11.5 lb/ft.

In such an angled configuration, solar apparatus support structure 100 as described herein can resist wind loads 158 and 160 which can support the structures placed atop or on the support structure. The structures described can resist wind speeds of about 90 mph to about 150 mph, about 100 mph to about 140 mph, about 110 mph to about 130 mph, at least about 50 mph, at least about 60 mph, at least about 70 mph, at least about 80 mph, at least about 90 mph, at least about 100 mph, at least about 110 mph, at least about 120 mph, or any load value bound by, or between any of these values. In one embodiment, the structures can resist wind speeds of at least about 90 mph. The structures described can resist positive or negative normal wind loads of about 10,000 N to about 40,000 N, about 15,000 N to about 35,000 N, about 20,000 N to about 30,000 N, at least about 1,000 N, at least about 5,000 N, at least about 10,000 N, at least about 15,000 N, at least about 20,000 N, or any load value bound by, or between any of these values. In one embodiment, the structures can resist a positive or negative normal wind load of at least about 13,800 N. In another embodiment, the structures can resist a positive or negative normal wind load of at least about 38,533 N.

The solar apparatus support structure 100 described can have a first foundation 110 and second foundation 124 which support an axial compressive load 155, axial tensile load 156 and lateral loads 153 and 154. The foundation described can resist total axial compressive loads of about 1,000 N to about 40,000 N, about 7,500 N to about 20,000 N, about 10,000 N to about 18,000N or any load value bound by, or between any of these values. In one embodiment, solar apparatus support structure foundation 110 and 124 can resist an axial compressive load of at least about 15,800 N. In another embodiment, solar apparatus support structure foundation 110 and 124 can resist an axial compressive load of at least about 40,012 N.

The solar apparatus support structure foundations 110 and 124 described can also resist total axial tensile loads of at least about 1,000 N, about 5,000 N, about 10,000 N, about 20,000 N, about 30,000 N or more, or any load value bound by, or between any of these values. In one embodiment, solar apparatus support structure foundations 110 and 124 can resist an axial tensile load of at least about 8,100 N. In another embodiment, solar apparatus support structure foundations 110 and 124 can resist an axial tensile load of at least about 25,564 N.

The solar apparatus support structure foundations 110 and 124 described can also resist total lateral loads of at least about 500 N, about 5,000 N, about 10,000 N, about 15,000 N, about 20,000 N or more, or any load value bound by, or between any of these values. In one embodiment, solar apparatus support structure foundations 110 and 124 can resist a lateral load of at least about 6,400 N. In another embodiment, solar apparatus support structure foundations 110 and 124 can resist a lateral load of at least about 16,716 N.

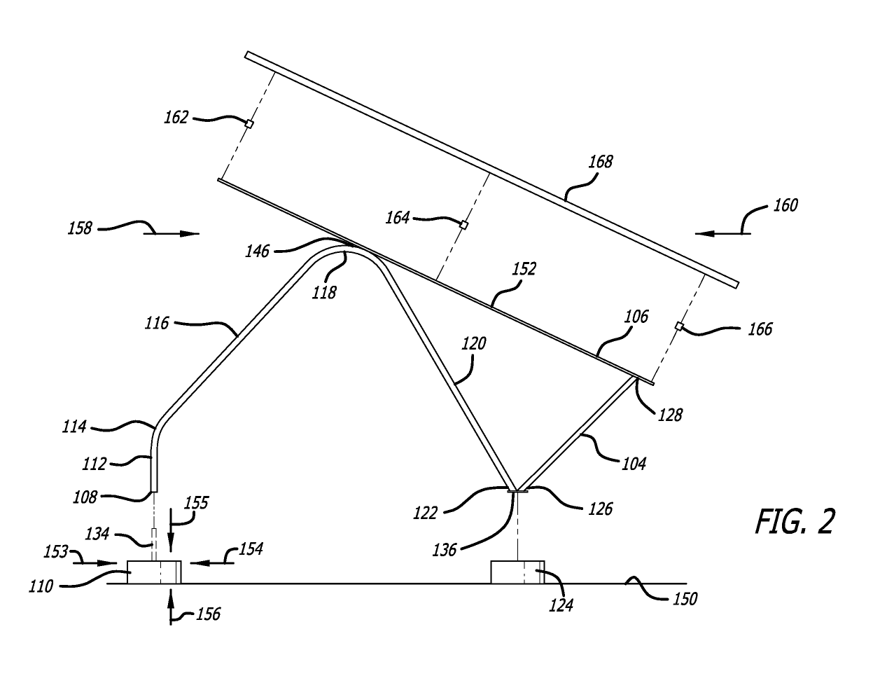

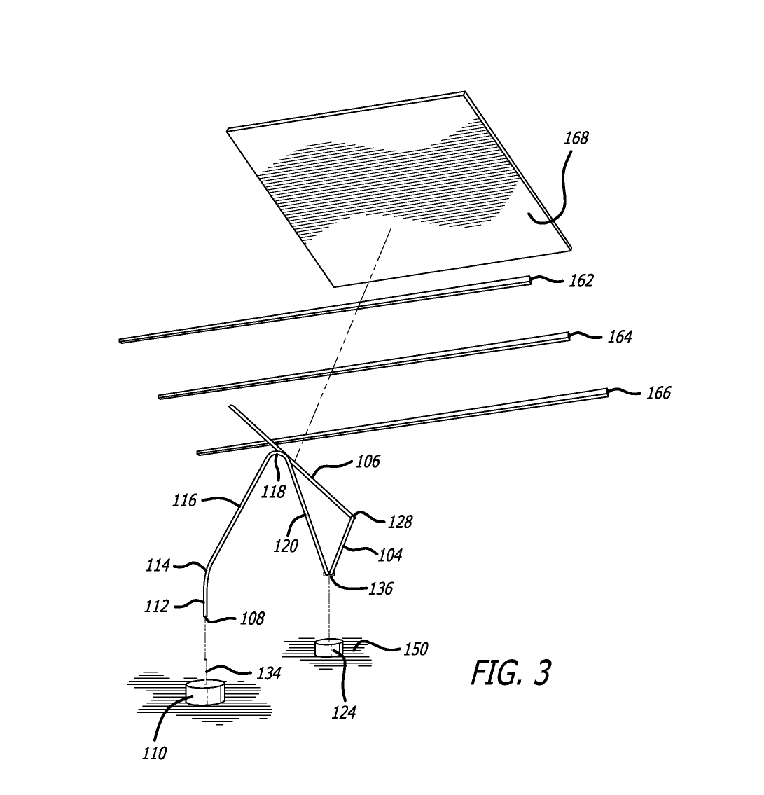

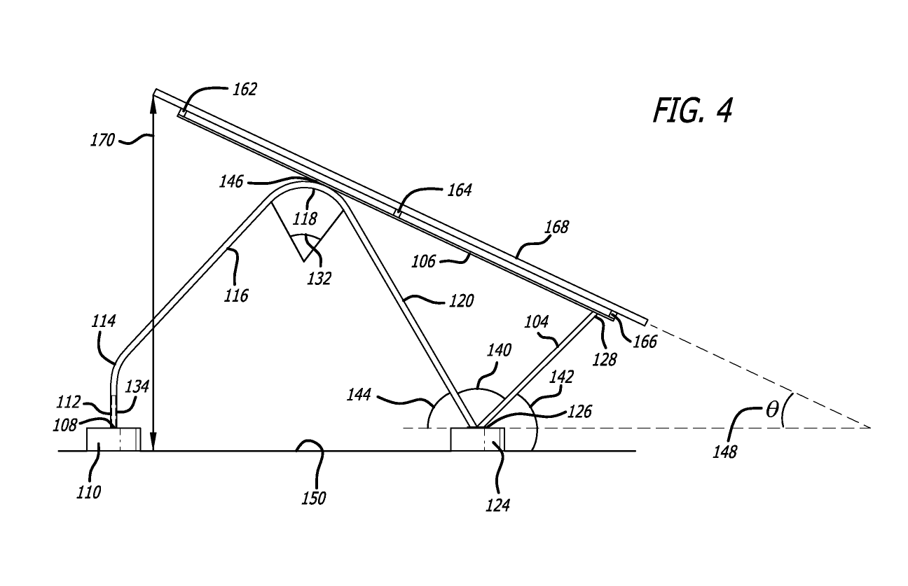

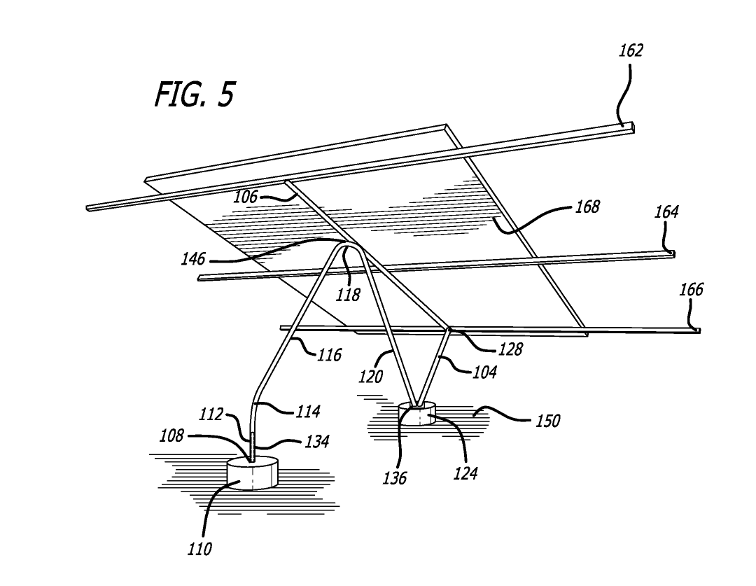

As illustrated in FIGS. 2-5, once a support structure has been erected, two or more joists can be associated with top surface 152. In FIG. 2-5, an exemplary embodiment is illustrated including first joist 162, second joist 164 and third joist 166 all arranged perpendicular to linear coupling member 106. However, any number of joists can be used to support solar apparatus depending on such properties as weight, terrain, and weather conditions (e.g. wind).

One or more solar apparatus 168 can be secured to the at least two joists, in FIGS. 2-5, first joist 162, second joist 164 and third joist 166. Each solar apparatus 168 can independently include one or more solar arrays, solar panels, solar modules, solar thermal panels, solar thermal modules, solar thermal arrays, mirrors used in solar thermal energy production, mirrors used for solar furnace systems, mirrors in solar energy collection systems and the like or any component that can track the sun, and combinations thereof. Further, each solar apparatus 168 can have a planar shape, a concave shape or a convex shape.

Joists can protrude beyond solar apparatus, can be substantially as wide as solar apparatus, or solar apparatus can be wider than the joists. The joists can provide a distribution of the weight of solar apparatus and or can provide a means of conveniently attaching solar apparatus to solar apparatus support structure.

The entire solar system, e.g. a solar apparatus support system including a solar support structure and one or more solar apparatus, can have a height sufficient to allow use of the surrounding land. Unlike most solar fields which require large concrete foundations and low hanging equipment, the present systems allow at least a portion of the equipment (e.g. one or more solar apparatus) to sit at height 170. Height 170 can allow at least partial use of the land. Further, the use of small post foundations, land is freely usable, for example, to store equipment, allow sheep or cattle to graze, grow crops, build structures, and the like.

Further, in some embodiments, the structures and systems described herein can be light weight. First curved member 102, first linear member 104, and linear coupling member 106 can collectively weigh less than about 600 lbs, less than about 500 lbs, less than about 400 lbs, less than about 300 lbs, less than about 200 lbs, less than about 100 lbs, less than about 50 lbs, less than about 25 lbs or any weight bound by, or between any of these values. In other embodiments, the collective weight is from about 50 lbs to about 600 lbs, about 50 lbs to about 300 lbs, or about 100 lbs to about 200 lbs. The light weight of the arms allows one or more skilled artisan(s) to potentially lift and install the arms without the aid of heavy machinery.

The structures and systems described herein can comprise first curved member 102, first linear member 104, and linear coupling member 106 which together form a multi-triangular unit or truss converting vertical and horizontal forces into axial loads. The geometry of the truss can define how much tension and compression can be transferred to each member thus allowing the designer to reduce the axial load on one member while increasing it in the other as needed. The truss can also be structurally more efficient than a single pier or post support system, and as a result, the deflection due to the lateral loads can be minimized. This property of conversion can further be realized when using shallow column post tensioned foundations.

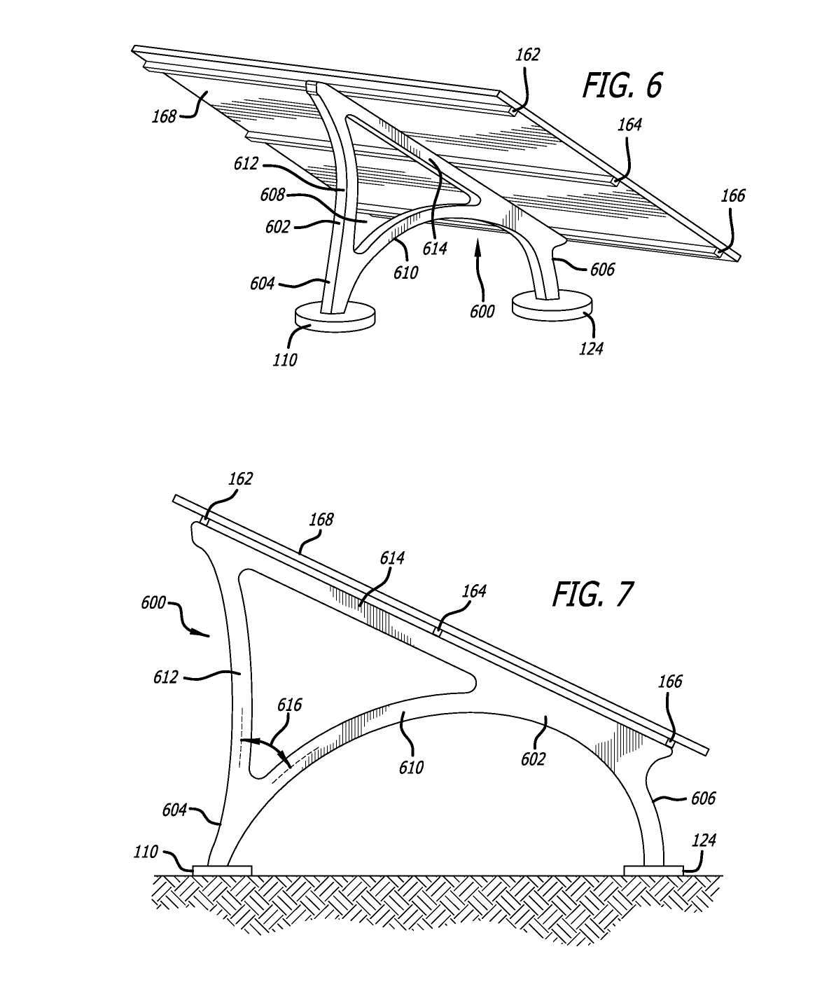

Another solar apparatus support structure 600 according to the present description is illustrated in FIGS. 6-7. In FIG. 6-7, structure 600 includes a unibody design. Unibody 602 includes a first curved member, a first linear member, and linear coupling member all as one single unit. In other embodiments, at least two of a first curved member, a first linear member, and linear coupling member can be formed as a single unit while the remaining piece is separate. Unibody 602 can include first end 604 coupled to first foundation 110 and second end 606 attached to second foundation 124.

Unibody 602 can further include open portion 608. Open portion can have any shape that allows solar apparatus support structure 600 to sustain weight and forces applied to it under normal use. In one embodiment, open portion is substantially triangular. Open portion 608 can be formed by the intermingling of arch portion 610 on the underside of unibody 602, rear post portion 612 on first end 604, and linear coupling portion 614.

In one embodiment, unibody 602 can be a fusion of the main components of solar apparatus support sturture 100. For example, arch portion 610 (e.g., first curved member) and rear post portion 612 (e.g., first linear member) can serve a similar function as first curved member 102 and first linear member 104 in FIG. 1. Likewise, linear coupling portion 614 (e.g., linear coupling member) can serve a similar function as linear coupling member 106.

Arch portion 610 and rear post portion 612 can be separated by angle 616. Angle 616 can be about 30 degrees, about 40 degrees, about 45 degrees, about 50 degrees, about 60 degrees, about 70 degrees, about 75 degrees, about 80 degrees, about 90 degrees, about 100 degrees, about 110 degrees, about 120 degrees, about 130 degrees, about 140 degrees, about 150 degrees, about 160 degrees, about 170 degrees, between about 45 degrees and about 170 degrees, between about 60 degrees and about 150 degrees, between about 90 degrees and about 140 degrees, between about 110 degrees and about 130 degrees, or between about 45 degrees and about 100 degrees

Further, the design of unibody 602 can provide a support structure with similar center of gravity characteristics as solar apparatus support structure 100.

Also, solar apparatus support structure 600 can include first joist 162, second joist 164 and third joist 166 all arranged perpendicular to linear coupling portion 614. One or more solar apparatus 168 can be secured to the at least two joists. Here, first joist 162, second joist 164 and third joist 166 are all used to secure solar apparatus 168. As described, any number or kind of joists can be used and any number or type of solar apparatus can be used.

Unibody 602 can be formed of any material that can sustain weight and forces applied to it under normal use. Such materials can include, but are not limited to, plastic, GFRP, carbon fiber, metal, metal alloy, concrete or a combination thereof. Examples of metals include aluminum, titanium, iron, and other common structural metals. Examples of metal alloys can include steel. Concrete can include common cement, aggregate, light weight aggregates, fly ash, reinforcing, and the like.

Unibody 602 can be formed by any method that can result in a unibody structure that can sustain weight and forces applied to it under normal use. For example with fluid starting materials such as plastic or cement, simple molds can be used or more elaborate injection molding techniques can be used. In one embodiment, a simple mold can be filled with light weight cement and steel fiber reinforcing (SFR) and allowed to cure. The cured unibody structure can be deployed within about 30 min, about 1 hr, about 6 hr, about 12 hr, about 18 hr, about 1 day, about 2 days, about 3 days, about 4 days, about 5 days, about 10 days, about 15 days, about 20 days, about 25 days, about 28 days, about 30 days, about 35 days, about 40 days, about 45 days, about 50 days, between about 1 hr and about 50 days, between about 1 day and about 30 days, between about 5 days and about 20 days, or between about 10 days and about 30 days.

Unibody 602 can also be relatively light weight. For example, unibody 602 can weigh less than about 600 lbs, less than about 500 lbs, less than about 400 lbs, less than about 300 lbs, less than about 200 lbs, less than about 100 lbs, less than about 50 lbs, less than about 25 lbs, between about 50 lbs to about 600 lbs, between about 50 lbs to about 300 lbs, or between about 100 lbs to about 300 lbs, or any weight bound by, or between any of these values.

Methods of installing solar apparatus support structures and systems are also described. As a first step, a site for installing a solar apparatus, whether it be a single array or panel or an entire farm, is determined. As described above, the present systems can be installed high enough allowing for more flexibility in placement. Installation in conjunction with shallow column foundations may be desirable. In other embodiments, installation in conjunction with shallow column foundations may not be desirable for reasons such as foundations already exist.

Once a location has been determined, one or more foundations can be installed in order to attach a solar apparatus support structure as described. A foundation can include, but is not limited to, a cement slab, a ballasted mount, an anchor, a post foundation pier, a post tensioned shallow gravel column foundation as described in Applicants United States provisional patent application No. 61/526,192, or the like. In one embodiment, two shallow gravel column foundations can be installed. In one embodiment, the foundations are installed perpendicular to the ground in a vertical arrangement. In some embodiments, the foundations can be guided during installation by a laser sight, sonar system, GPS or total station machine control systems or the like. In other embodiments, the foundations can be installed at an angle if a particular application requires it. In other embodiments, the foundations can be installed perpendicular to the horizon in cases with sloping ground to assure accurate alignment of the support structure relative to the sun's orientation.

During shallow column foundation installation, a tensioning rod can be structured to emanate from the top of at least the first foundation. Generally, the tensioning rod can protrude at a distance that can provide the structure with the ability to sustain a given load. This protrusion can be about 2 inches, about 6 inches, about one foot, about two feet, about three feet or more.

In other embodiments, a bolt, dowel, or rod can be bolted, welded or glued to an existing foundation or to a newly formed concrete pad, helical or driven pier, or other foundation. In other embodiments, the members can be attached directly to a foundation not including a tensioning rod.

At this point, adhesive can be either placed on the tensioning rod and/or within the internal cavity of first curved member 102, first curved member 102 can be slipped over the tensioning rod and bonded into place. Then, plate 136 can be glued or bolted to a second foundation.

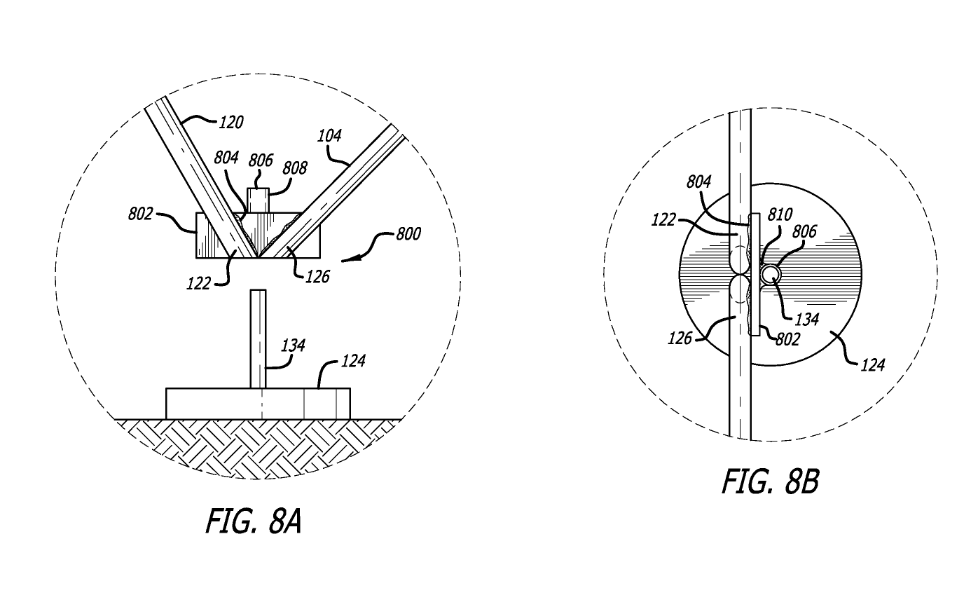

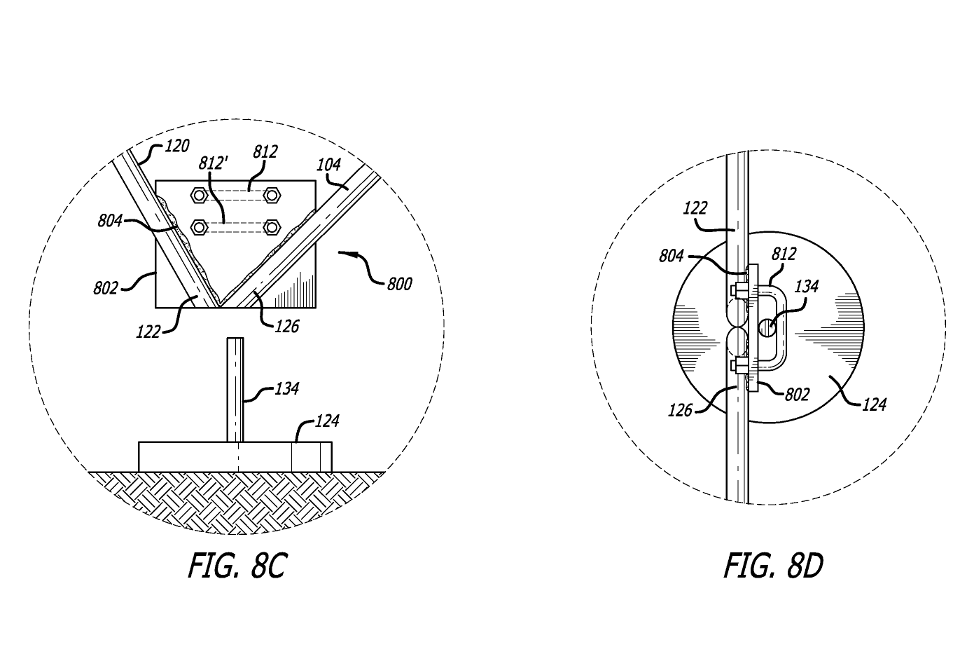

In another embodiment, as illustrated in FIGS. 8A and 8B, first linear member 104 and third linear section 120 can be wed to second foundation 124 using adjustable attachment apparatus 800. Adjustable attachment apparatus 800 includes plate 802 which can be any shape that allows attachment of first linear member 104 and third linear section 120. In some embodiments, plate 802 can be square, triangular, rectangular, rectilinear, circular, an ellipse, or the like. In other embodiments, plate 802 can be added to apparatus 100 prior to arriving at the installation site. First linear member 104 and third linear section 120 can be attached to plate 802 using any means known in the art. For example, in one embodiment, bonding residue 804 can be used to attach first linear member 104 and third linear section 120 to plate 802. Bonding reside 804 can be an adhesive, a weld, or the like.

In still another embodiment, as illustrated in FIGS. 8C and 8D, first linear member 104 and third linear section 120 can be wed to second foundation 124 using adjustable attachment apparatus 800. Adjustable attachment apparatus 800 includes plate 802. Plate 802 can have 1, 2, 3, 4, 5 6, 7, 8 or more predrilled holes permitting attachment of a retaining apparatus 812 such as a “U” bolt to fit around tension rod 134 and when tightened structurally secures plate 802 to second foundation 124. Other types of retaining apparatus 812 can be used such a loops or rings, coils, vice grips, slotted holes, or the like. Plate 802 can be any shape that allows attachment of first linear member 104, third linear section 120, and retaining apparatus 812. In some embodiments, plate 802 can be square, triangular, rectangular, rectilinear, circular, an ellipse, or the like. In other embodiments, plate 802 can be added to apparatus 100 prior to arriving at the installation site. First linear member 104 and third linear section 120 can be attached to plate 802 using any means known in the art. For example, in one embodiment, bonding residue 804 can be used to attach first linear member 104 and third linear section 120 to plate 802. Bonding reside 804 can be an adhesive, a weld, or the like. At this point, apparatus 100 is affixed to second foundation 124.

First linear member 104 and third linear section 120 coupled to plate 802 can be positioned as desired (e.g. leveled) upon second foundation 124. Then, or alternatively before placement, sleeve 806 is placed over tensioning rod 134. Sleeve 806 can attach or couple to tensioning rod 134. In one embodiment, if tensioning rod 134 is circular in cross section, sleeve 806 can be a cylindrical tube that can have an interior diameter that is slightly larger than the outer diameter of the tensioning rod's cross section.

Sleeve 806 can be slid over or threaded onto tensioning rod 134. In one embodiment, sleeve 806 can provide a snug fit around tensioning rod 134, for example by being tapered smaller at its top end 808. In either case, sleeve 806 can be glued, welded, or otherwise bonded to tensioning rod 134 to achieve a secure fit between the two parts.

After apparatus 100 has been properly positioned, plate 802 can be bonded or fixed to sleeve 806 using any means known in the art. In one embodiment, bonding reside 810 is used. Bonding reside 810 can be an adhesive, a weld, or the like. In one embodiment, bonding reside 804 and bonding reside 810 are the same. In other embodiments, bonding reside 804 and bonding reside 810 are different. In another embodiment, fixing sleeve 806 to plate 802 is accomplished using attachment apparatus 812 such as a “U” bolt(s) that compress tension rod 134 to plate 802. At this point, apparatus 100 is affixed to second foundation 124.

In some embodiments, apparatus 100 can be attached to first foundation 110 using a similar or modified adjustable attachment apparatus 800.

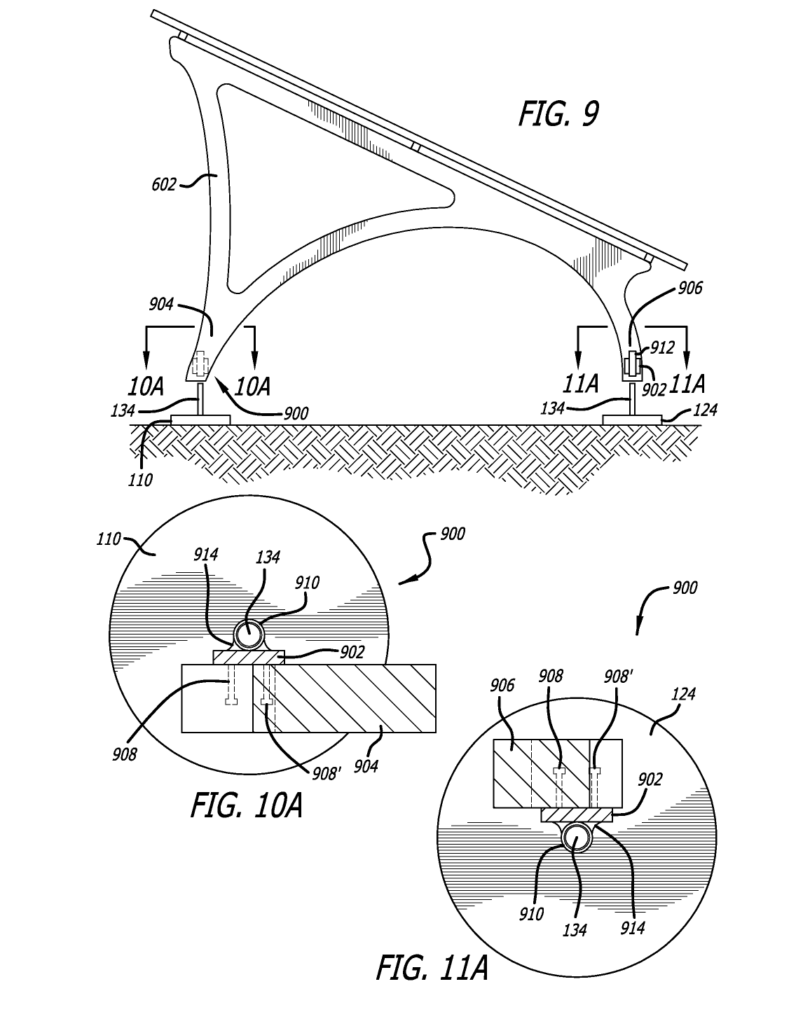

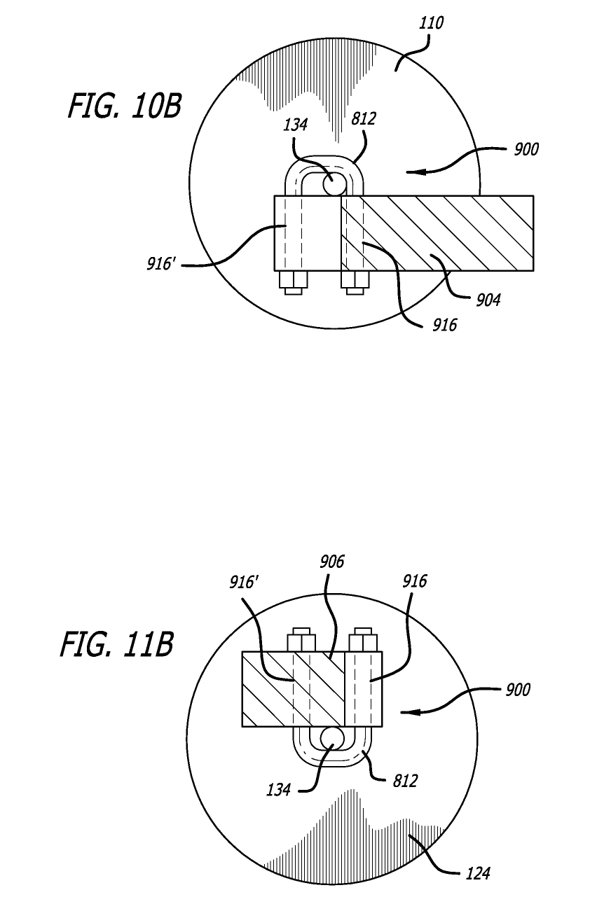

In another embodiment, as illustrated in FIG. 9-11, unibody 602 can be attached to first foundation 110 and second foundation 124 using adjustable attachment system 900. Similar to adjustable attachment apparatus 800, adjustable attachment system 900 includes a plate 902 which can be any shape that allows attachment of first unibody leg 904 and/or second unibody leg 906 to first foundation 110 and/or second foundation 124. In some embodiments, plate 902 can be square, triangular, rectangular, rectilinear, circular, an ellipse, or the like. In other embodiments, plate 902 can be added to unibody 602 prior to arriving at the installation site and can be attached using any means known in the art. For example, in one embodiment, imbedded bolts 908, 908′ can be used to attach plate 902 to first unibody leg 904 and/or second unibody leg 906. A bonding reside can also be used to attach plate 902 to unibody 602 and can be an adhesive, a weld, or the like.

Unibody 602 coupled to plate 902 can be positioned as desired (e.g. leveled) upon first foundation 110 and/or second foundation 124. Then, or alternatively before placement, sleeve 910 is placed over tensioning rod 134. Sleeve 910 can be secured onto, attached, adhered to, or coupled to tensioning rod 134. In one embodiment, if tensioning rod 134 is circular in cross section, sleeve 910 can be a cylindrical tube that can have an interior diameter that is slightly larger than the outer diameter of the tensioning rod's cross section.

Sleeve 910 can be slid over or threaded onto tensioning rod 134. In one embodiment, sleeve 910 can provide a snug fit around tensioning rod 134, for example by being tapered smaller at its top end 912. Sleeve 910 can be glued, welded, or otherwise bonded to tensioning rod 134 to achieve a secure fit between the two parts.

After unibody 602 has been properly positioned, plate 902 can be bonded to sleeve 910 using any means known in the art. In one embodiment, bonding reside 914 is used. Bonding reside 914 can be an adhesive, a weld, or the like. At this point, unibody 602 is affixed to its foundation(s). In some embodiments, plates can be placed on the same or different sides or faces of first unibody leg 904 and/or second unibody leg 906.

Then, at least two joists can be mounted to linear coupling member 106 at a substantially perpendicular orientation. In one embodiment, the joists are welded to linear coupling member 106. On top of the joists can be anchored at least one solar apparatus 168. In one embodiment, the solar apparatus is a solar panel or solar array.

Then, a second and subsequent structure(s) can be installed until a desired number of solar apparatus are installed. Electrical components of the solar apparatus can be installed before or after a second or subsequent structure is erected.

The systems and methods described herein can save time when compared to common methods and systems. For example, the present systems and methods can use post tensioned shallow gravel foundations in contrast to full concrete, helical or driven steel pier foundations for solar apparatus arrays currently used in the art. Current concrete foundations can take several days to cure before solar arrays can be assembled on top. The present systems and methods' foundations can be installed in a matter of hours and solar arrays installed within a day or two. In some embodiments, the present systems and methods can save about 2 days, about 3 days, about 4 days, about 5 days, about 6 days, about a week, about 2 weeks about 3 weeks, about 4 weeks, or any amount of time bound by, or between any of these values, when compared to currently used systems and methods.

Further, the present systems can be easily decommissioned. Current concrete foundation systems require elaborate machinery and substantial haul-away efforts when the solar arrays are decommissioned. Such efforts can require substantial amounts of time and money. For example, deep driven piers (4 to 5m) require substantial excavation and power requirements to remove the piers. In contrast, the present systems can be decommissioned in less time and for less money. In some embodiments, no elaborate machinery is required to decommission the present systems. In some embodiments, all that is needed is a small excavator.

A small excavator can use less than about 70 hp, about 60 hp, about 50 hp or about 40 hp of flywheel power to decommission the present systems. The small excavator can use less than about 70 kN, about 50 kN, about 40 kN, about 30kN, about 20 kN or about 10 kN or drawbar pull to decommission the present systems.

The support structure materials can be removed by hand and can be completely recyclable. In other embodiments, no jack-hammering is required with decommission of the present systems.

In some embodiments, at least some of the foundation and array components can be recyclable or at least formed of recyclable material(s). In one embodiment, all of the foundation and array components can be recyclable.

The above can translate into savings in both time and/or money. For example, a one day job using the present systems and methods can be substantially less expensive than a full concrete foundation system taking a week or more to complete. Further, the materials alone to construct the present systems can be lower priced than those used in current systems. For example, because some embodiments of the present systems and methods do not use or require formed concrete, there can be no need for expensive materials and machinery to excavate soil, pour and cure concrete (e.g. aggregate, water, rebar, wood framing, mixers, pumping systems, etc.). In some embodiments, all that is needed to install a foundation according to the present description is a reaction plate and rod assembly, aggregate, a top plate, a pressurized hammer, a mandrel and optionally a casing for the mandrel.

### EXAMPLE 1

Based on the above description, many different configurations can be envisioned by one skilled in the art. The following are non-limiting designs that can be used to determine generic or typical design characteristics useful in calculating loads and structural member sizing.

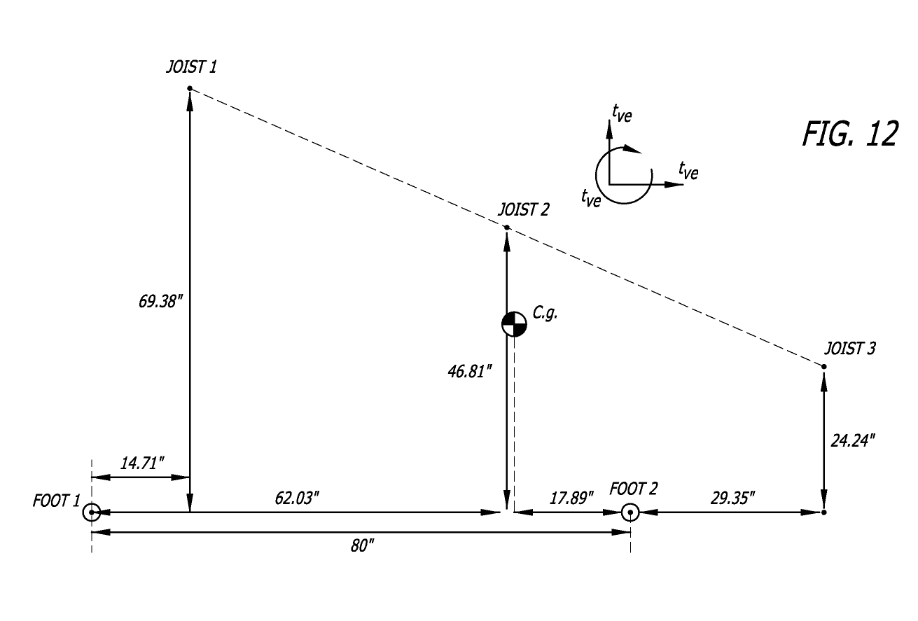

The angle of the solar panels was set to 25.5° , giving 97% of the maximum possible yearly output for a site located in Montalto di Castro, Italy at 42°21′36″N and 11°31′19″E. Basic dimensions of the structure were chosen such that the lowest edge of the solar panels (SunPower 315 modules) was no lower than 24 inches from the flat ground plane. Three joists were used to support the panels. The spacing between the two foundations was 80 inches, maximized so as to create lower foundation loads. The foundations anchored the steel members. The structures themselves were spaced 14 ft apart. Data for various systems and loads are listed in Tables 1 and 2. FIG. 12 illustrates design parameters used.

TABLE 1
Apparatus in FIG. 1

| | | Wind Speed, m/s (mph) | | | |
|---|---|---|---|---|---|
| | | 40 (90) | | 67 (150) | |
| Member Item Number | | Member Size | Member Strength | Member Size | Member Strength |
| 102 and 104 | | 1.25″ f Sched. 40 | f_{y} = 35 ksi (A53 Gr. | 2″ f Sched. 80 | f_{y} = 35 ksi (A53 Gr. |
| | | (STD) | B) | (XH) | B) |
| 106 | | C5 × 6.7 | f_{y} = 36 ksi (A36) | C8 × 11.5 | f_{y} = 36 ksi (A36) |
| | | (Channel) | | (Channel) | |
| 610, 612, 614 | | — | — | — | — |
| | | Frame Weight, kg (lb) | | | |
| | | 42.0 (92.7) | | 79.7 (175.7) | |
| Dimensions | | m (in) | | m (in) | |
| A | | 1.762 (69.38) | | 1.762 (69.38) | |
| B | | 1.189 (46.81) | | 1.189 (46.81) | |
| C | | 0.616 (24.24) | | 0.616 (24.24) | |
| D | | 0.374 (14.71) | | 0.374 (14.71) | |
| E | | 1.576 (62.03) | | 1.576 (62.03) | |
| F | | 2.032 (80.00) | | 2.032 (80.00) | |
| G | | 0.745 (29.35) | | 0.745 (29.35) | |
| | | Wind Direction | | | |
| | | + Wind, N (lb) | − Wind, N (lb) | + Wind, N (lb) | − Wind, N (lb) |
| 1^{st} | Axial | 1,041 (234) | −5,138 (−1,155) | 1,588 (357) | −15,747 (−3,540) |
| Foundation | (Rᵥ₁) | | | | |
| Loads | Lateral | 947 (213) | −4,453 (−1,001) | 1,646 (370) | −13,505 (−3,036) |
| | (Rₕ₁) | | | | |
| 2^{nd} | Axial | 15,760 (3,543) | −5,529 (−1,243) | 40,012 (8,995) | −19,715 (−4,432) |
| Foundation | (Rᵥ₂) | | | | |
| Loads | Lateral | −947 (−213) | 4,453 (1,001) | −1,646 (−370) | 13,505 (3,036) |
| | (Rₕ₂) | | | | |

TABLE 2
Apparatus in FIG. 6

| | | Wind Speed, m/s (mph) | | | |
|---|---|---|---|---|---|
| | | 40 (90) | | 67 (150) | |
| Member Item Number | | Member Size | Member Strength | Member Size | Member Strength |
| 102 and 104 | | — | — | — | — |
| 106 | | — | — | — | — |
| 610, 612, 614 | | 4″ × 3″ | f_{c} = 3,000 psi | 4″ × 3″ | f_{c} = 5,000 psi |
| | | Frame Weight, kg (lb) | | | |
| | | 100.4 (221.3) | | 100.4 (221.3) | |
| Dimensions | | m (in) | | m (in) | |
| A | | 1.764 (69.44) | | 1.764 (69.44) | |
| B | | 1.190 (46.87) | | 1.190 (46.87) | |
| C | | 0.617 (24.30) | | 0.617 (24.30) | |
| D | | 0.075 (2.94) | | 0.075 (2.94) | |
| E | | 1.127 (44.38) | | 1.127 (44.38) | |
| F | | 2.252 (88.65) | | 2.252 (88.65) | |
| G | | 0.077 (3.05) | | 0.077 (3.05) | |
| | | Wind Direction | | | |
| | | +Wind, N (lb) | −Wind, N (lb) | +Wind, N (lb) | −Wind, N (lb) |
| 1^{st} | Axial | 6,001 (1,349) | −8,047 (−1,809) | 13,847 (3,113) | −25,564 (−5,747) |
| Foundation | (Rᵥ₁) | | | | |
| Loads | Lateral | 6,352 (1,428) | −5,240 (−1,178) | 16,716 (3,758) | −15,822 (−3,557) |
| | (Rₕ₁) | | | | |
| 2^{nd} | Axial | 10,800 (2,428) | −2,624 (−590) | 27,744 (6,237) | −9,902 (−2,226) |
| Foundation | (Rᵥ₂) | | | | |
| Loads | Lateral | −6,352 (−1,428) | 5,240 (1,178) | −16,716 (−3,758) | 15,822 (3,557) |
| | (Rₕ₂) | | | | |

The total weight of the system was about 504.3 lb. The structure components made up of the support structure, the joist, and the modules can each be lifted by humans without a need for heavy lifting equipment.

The horizontal placement of the center of gravity was found using standard geometric formulae. The correct center of gravity placement can be important in resisting overturning moments generated by wind forces. Taking the center of the first linear member, on the top face of the second foundation to be the datum, the following data was generated.

To calculate wind loading, a standard formula for wind loading normal force was used for a gust of wind speed 90 mph. The coefficient of normal force was estimated. Data generated are shown in the Table below.

The distribution of the wind load onto the structure can greatly affect the outcome. Having three joists holding the solar panels can make for a statistically indeterminate structure, which means that the wind load distribution onto the three joists cannot be determined by ordinary methods. As such, formulas using deflection equilibrium were used.

Two loading cases were applied (wind blowing onto upper surface and wind blowing onto lower surface). In both cases, the load substantially rests on the center.

Case 1: It was assumed that all horizontal reaction at ground level arises from a force interaction applied as a point load level with the top of the concrete feet. This lateral load can be transferred to the length of the gravel columns. There can exist a vertical and a horizontal reaction on both feet, referred to as Rᵥ₁, Rₕ₁, Rᵥ₂ and Rₕ₂. It can also be assumed that the piles provide no moment reaction, which also is necessary for the analysis to be made. Positive axial loads are compressive and negative axial loads are tensile and lateral loads are expressed relative to wind direction as shown in FIG. 12.

The Rᵥ₂ illustrates that the reaction is upwards and resisted by the foundation. The Rᵥ₁ again illustrates that the reaction is upwards and resisted by the foundation. The reaction forces for both feet are upwards suggesting that the structure may not have a tendency to overturn. To evaluate the horizontal forces, it can be assumed that the horizontal forces are proportional to the vertical reaction forces. These horizontal forces can be resisted by the shallow columns themselves, in some embodiments.

Case 2: The second load case has the wind blowing from behind (up onto the lower surface of the panels) causes Foot 1 to tend to lift off the ground, meaning the foundation must engage the soil in tension to resist this.

The Rᵥ₂ illustrates that the reaction is downwards and resisted by the foundation's tension. The Rᵥ₁ again illustrates that the reaction is downwards and resisted by the foundation's tension. For case 2, both reaction forces can be downwards, meaning the foundations can both be able to pull down keeping the structure from lifting up.

For the horizontal reaction forces, it can be assumed that the horizontal forces are proportional to the vertical reaction forces. These horizontal forces can be resisted by the shallow columns themselves, in some embodiments.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, references have been made to patents in this specification. The above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A solar apparatus support structure comprising:
a first curved member and a first linear member joined at a point; and
a linear coupling member adjoined to the first curved member at a first connection point and the first linear member at a second connection point,
wherein the solar apparatus support structure is configured to resist a wind load of at least about 13,900 N.

2. The solar apparatus support structure according to claim 1, further comprising a first foundation and a second foundation.

3. The solar apparatus support structure according to claim 2, wherein the first foundation and the second foundation are shallow gravel column foundations.

4. The solar apparatus support structure according to claim 1, wherein the first curved member and the first linear member are tubular.

5. The solar apparatus support structure according to claim 1, wherein the first curved member, the first linear member, and the linear coupling member are formed as a single unit.

6. The solar apparatus support structure according to claim 1, wherein the first curved member and the first linear member are separated by an angle of between about 30 degrees and about 100 degrees.

7. The solar apparatus support structure according to claim 1, wherein the linear coupling member is adjoined to the first linear member at an end opposite to the foundation.

8. The solar apparatus support structure according to claim 1, wherein the first curved member includes at least two angles.

9. The solar apparatus support structure according to claim 1, further comprising at least two joists coupled perpendicularly to the linear coupling member.

10. The solar apparatus support structure according to claim 9, further comprising a solar apparatus mounted to the at least two joists.

11. The solar apparatus support structure according to claim 10, wherein the solar apparatus includes at least one of a solar array, a solar panel, a solar module, a solar thermal panel, a solar thermal module, a solar thermal array, a mirror used in solar thermal energy production, a mirror used for a solar furnace system, a mirror in a solar energy collection system, a component that can track the sun, or a combination thereof.

12. A method of installing a solar support structure comprising:
a. affixing a first end of a first curved member to a first foundation, and a second end of the first curved member and a second first end of the first linear member to a second foundation;
b. joining a linear coupling member to the first curved member at a first connection point and the second linear member at a second connection point;
c. attaching at least two joists to the linear coupling member; and
d. attaching at least one solar apparatus to the at least two joists.

13. The method according to claim 12, wherein the first curved member and the first linear member have a circular cross-section.

14. The method according to claim 12, wherein the first foundation and the second foundation are shallow column foundations.

15. The method according to claim 12, wherein the first curved member and the first linear member are separated by an angle of about 75 degrees.

16. The method according to claim 12, wherein the joining step is accomplished using at least one of an adhesive, a weld, or a bolt.

17. The method according to claim 12, wherein the first curved member, first linear member, and linear coupling member are joined before assembly at an installation site.

18. The method according to claim 12, wherein the first curved member, first linear member, and linear coupling member are formed as a single unit.

19. The method according to claim 12, wherein the at least one solar apparatus includes at least one of a solar array, a solar panel, a solar module, a solar thermal panel, a solar thermal module, a solar thermal array, a mirror used in solar thermal energy production, a mirror used for a solar furnace system, a mirror in a solar energy collection system, a component that can track the sun, or a combination thereof.

20. A solar support structure comprising:
a unibody structure including a first curved member, a first linear member, and linear coupling member formed of a lightweight concrete;
at least two joists coupled to the unibody structure; and
at least one solar apparatus joined to the at least two joists
